(19) United States
(12) Patent Application Publication
(10) Pub. No.: US 2026/0318348 A1
(43) Pub. Date: Oct. 15, 2026

(54) Anti-Detachment Fastening Device And Working Machinery

(71) Applicant: Caterpillar Inc., Peoria, IL (US)

(72) Inventors: Qiujun Gu, Wuxi City (CN); Jian Wang, Wuxi City (CN); Peng Zhao, Wuxi City (CN); Guangxian Zuo, Wuxi City (CN); Shuguang Liu, Wuxi City (CN)

(21) Appl. No.: 19/466,993

(22) Filed: Feb. 2, 2026

(30) Foreign Application Priority Data
Feb. 19, 2025 (CN) 202510183227.2

(51) Int. Cl. F16B 39/04

(52) U.S. Cl. CPC F16B 39/04

(57) ABSTRACT

The present disclosure relates to an anti-detachment fastening device and working machinery having the same. The anti-detachment fastening device is suitable for fastening a part to a fixed base, the part being provided with a through hole, and the device further comprises a fastening member and an elastically deformable anti-detachment member. The fastening member comprises a shank portion which is capable of being inserted into and at least partially received within the through hole, a mounting groove being provided on an outer circumferential surface of the shank portion; the anti-detachment member is mounted within the mounting groove and extends at least partially radially outward beyond the mounting groove; a stop portion is provided inside the through hole of the part; and the anti-detachment member is configured to allow it to pass through the stop portion when the shank portion is inserted into the through hole along a first direction, enabling the fastening member and the base to enter a connected state, and to prevent the fastening member from detaching from the part along a second direction by abutting against the stop portion when the fastening member and the base transition to a disconnected state. The anti-detachment fastening device of the present disclosure is convenient for maintenance, improves assembly and disassembly efficiency, and can avoid incorrect or missed installation.

### CROSS-REFERENCE TO RELATED APPLICATIONS

This application claims priority to prior Chinese Patent Application Number CN 202510183227.2, filed Feb. 19, 2025, which is incorporated herein by reference in its entirety.

### TECHNICAL FIELD

The present disclosure relates to the technical field of components of working machinery, and in particular, to an anti-detachment fastening device and working machinery comprising the same.

### BACKGROUND ART

Threaded connection is one of the most widely used connecting methods in the structural design of components for working machinery, and is used to assemble two or more parts together. It is typically used for fixed connections that require detachability, offering advantages such as simple structure, reliable connection, convenient assembly and disassembly, and the like.

In existing design solutions, parts are secured to a base usually via fasteners such as bolts or double-ended studs by applying a tightening torque. During disassembly, the fasteners and parts are detached by applying a reverse torque. Since the fasteners are usually numerous, have various specifications, and are small in size, they are inconvenient to store and manage after being disassembled and can be difficult to identify if mixed up. This often causes inconvenience for subsequent reinstallation, resulting in lower assembly and disassembly efficiency.

Therefore, there is a need to propose an improved fastening solution to solve at least one of the above-mentioned problems and/or other problems existing in the prior art.

### SUMMARY OF THE INVENTION

To achieve the above objective, according to one aspect of the present disclosure, an anti-detachment fastening device is provided, for fastening a part to a fixed base. The part is provided with a through hole, and the anti-detachment fastening device comprises a fastening member and an elastically deformable anti-detachment member. The fastening member comprises a shank portion which is capable of being inserted into and at least partially received within the through hole, and an annular mounting groove is provided on an outer circumferential surface of the shank portion. The anti-detachment member is mounted within the mounting groove and extends at least partially radially outward beyond the mounting groove. A stop portion is provided inside the through hole of the part, and the anti-detachment member is configured such that, on one hand, it is allowed to pass through the stop portion when the shank portion of the fastening member is inserted into the through hole along a first direction, enabling the fastening member and the base to enter a connected state, and on the other hand, when the fastening member and the base transition from the connected state to a disconnected state, it prevents the fastening member from detaching from the part along a second direction opposite to the first direction by abutting against the stop portion.

According to one embodiment of the present disclosure, the stop portion is formed as an annular flange extending radially inward from an inner wall of the through hole of the part.

According to one embodiment of the present disclosure, the stop portion comprises a mounting guide surface in the form of a tapered surface. The mounting guide surface defines a mounting entry with a diameter gradually decreasing along the first direction, and the anti-detachment member has a mounting inclined surface capable of fitting with the mounting guide surface.

According to one embodiment of the present disclosure, the stop portion further comprises a stop surface, the anti-detachment member has an anti-detachment surface capable of fitting with the stop surface, and an outer diameter of the anti-detachment surface is greater than a minimum diameter of the mounting entry.

According to one embodiment of the present disclosure, the mounting groove is provided with a first tapered portion, a diameter of the first tapered portion gradually increasing along the first direction, and the anti-detachment member has a limiting inclined surface matched with the first tapered portion.

According to one embodiment of the present disclosure, the mounting groove is further provided with a second tapered portion located farther away from the base compared to the first tapered portion, a diameter of the second tapered portion gradually increasing along the second direction, thereby providing a space between the anti-detachment surface and a tapered surface defined by the second tapered portion when the anti-detachment member is in an undeformed state.

According to one embodiment of the present disclosure, the anti-detachment member is disposed within the mounting groove in an interference fit manner.

According to one embodiment of the present disclosure, the fastening member further comprises a head connected to the shank portion, and the anti-detachment fastening device further comprises a washer sandwiched between the head of the fastening member and the part.

According to one embodiment of the present disclosure, a threaded section is provided on at least part of a length of the shank portion, and the threaded section has an external thread and is intended to be threadedly connected to a threaded hole of the base.

According to another aspect of the present disclosure, a working machinery is provided, which comprises a fixed base, a part, and the aforementioned anti-detachment fastening device for fastening the part to the base.

The anti-detachment fastening device of the present disclosure provides such an anti-detachment member that, on one hand, when the shank portion of the fastening member is inserted into the through hole along the first direction, the anti-detachment member is allowed to pass through the stop portion, enabling the fastening member and the base to enter a connected state, and on the other hand, when the fastening member and the base transition from the connected state to a disconnected state, it can prevent the fastening member from detaching from the part along the second direction opposite to the first direction by abutting against the stop portion. In this way, when the part needs to be reinstalled onto the base, it is only necessary to directly apply torque to the fastening member, and therefore, compared to standard fasteners such as bolts and double-ended studs in the prior art, the anti-detachment fastening device according to the present disclosure is more convenient for maintenance, improves assembly and disassembly efficiency, and avoids incorrect or missed installation.

### BRIEF DESCRIPTION OF DRAWINGS

The features and advantages of the present disclosure will be clearly understood through the detailed description provided below with reference to the accompanying drawings. It should be understood that the following drawings are merely schematic and not necessarily drawn to scale, and therefore should not be considered as limiting the present disclosure, wherein:

FIG. 1 shows a schematic diagram of an anti-detachment fastening device according to an exemplary embodiment of the present disclosure, wherein the anti-detachment fastening device is in a pre-installation state ready to be installed to a part.

FIG. 2 shows a schematic diagram of the anti-detachment fastening device shown in FIG. 1 connecting a part and a base.

FIG. 3 shows a schematic diagram of the anti-detachment fastening device shown in FIG. 1, wherein the anti-detachment fastening device has been disconnected from the base and is in a disassembled state.

FIG. 4 shows a cross-sectional view of the part shown in FIG. 1 taken along its central axis.

FIG. 5 shows a perspective view of a fastening member of the anti-detachment fastening device shown in FIG. 1.

FIG. 6 shows a perspective view of an anti-detachment member of the anti-detachment fastening device shown in FIG. 1.

### Reference Numerals

1 part
11 through hole
12 stop portion
121 mounting guide surface
122 stop surface
2 base
21 threaded hole
3 fastening member
31 shank portion
32 mounting groove
321 first tapered portion
322 second tapered portion
33 head
34 threaded section
4 anti-detachment member
41 mounting inclined surface
42 anti-detachment surface
43 limiting inclined surface
5 washer
X first direction (i.e., mounting direction)
Y second direction (i.e., disassembly direction)

### DETAILED DESCRIPTION OF EMBODIMENTS

Embodiments of the present disclosure are described below with reference to the drawings. In the following description, numerous specific details are set forth to enable those skilled in the art to fully understand and implement the present disclosure. However, it will be apparent to those skilled in the art that the implementation of the present disclosure may not have some of these specific details. Furthermore, it should be understood that the present disclosure is not limited to the specific embodiments introduced. On the contrary, any combination of the features and elements described below may be considered to implement the present disclosure, regardless of whether they involve different embodiments. Therefore, the following aspects, features, embodiments and advantages are for ease of explanation only and should not be considered as elements or limitations of the claims, unless explicitly stated in the claims.

Terms such as “first”, “second”, etc. are used herein to describe elements of the present disclosure, whereas these terms are only used to distinguish the elements from each other, and are not intended to limit the nature, order or number of the elements. The terms “comprise” and “have” are used to indicate an open-ended meaning of inclusion, and mean that there may be additional elements/components besides the listed elements/components.

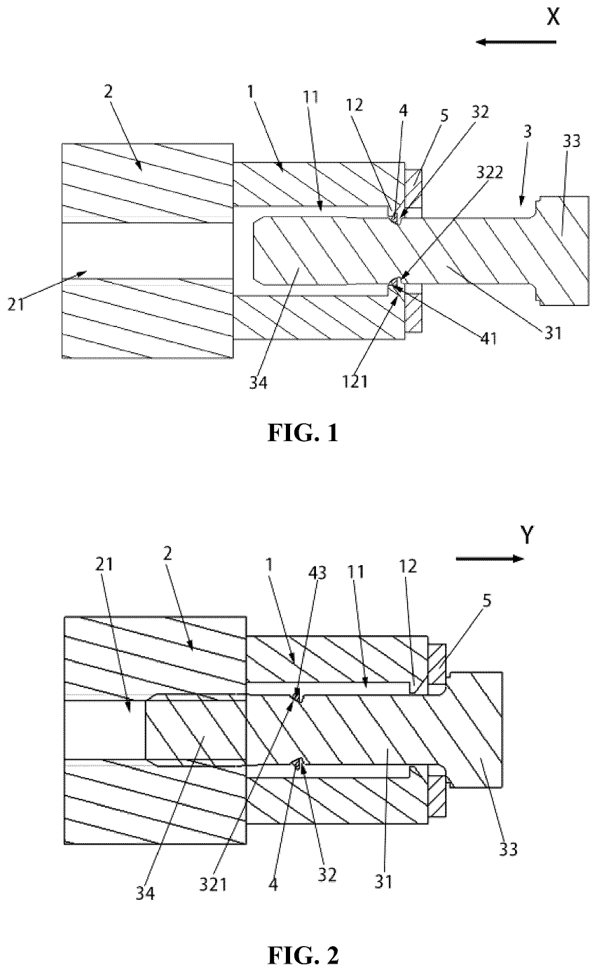

FIGS. 1-3 show an anti-detachment fastening device according to an embodiment of the present disclosure, for fastening a part 1 to a fixed base 2. FIG. 4 shows a schematic cross-sectional view of the part 1 taken along its central axis. As shown in FIGS. 1-4, the part 1 is provided with a through hole 11, and the base 2 is provided with a mounting hole corresponding to the through hole 11. The mounting hole may be a threaded hole 21 with an internal thread as shown in the figures. The through hole 11 of the part 1 and the mounting hole of the base 2 can be fixedly connected via the anti-detachment fastening device of this embodiment. As shown in FIGS. 1-3, the anti-detachment fastening device according to this embodiment may comprise a fastening member 3 and an anti-detachment member 4.

Referring to FIGS. 1-3 and FIG. 5, the fastening member 3 may comprise a shank portion 31 and a head 33. The shank portion 31 may comprise a smooth section connected to the head 33 and a threaded section 34 away from the head 33. The fastening member 3 can be inserted through the through hole 11 of the part 1 into the base 2, and is threadedly connected to the threaded hole 21 of the base 2 via an external thread of the threaded section 34, thereby achieving fixed connection between the part 1 and the base 2.

In this embodiment, an annular mounting groove 32 for receiving the anti-detachment member 4 is provided between the smooth section and the threaded section 34 of the shank portion 31. The radial width of the head 33 is greater than that of the shank portion 31. Thus, when the shank portion 31 passes through the through hole 11 of the part 1 to fasten the part 1 to the base 2, the head 33 can directly or indirectly abut against a side surface of the part 1 facing away from the base 2. The head 33 is formed as a hexagonal head, allowing torque to be applied via a tightening tool.

Continuing to refer to FIGS. 1-3, the anti-detachment member 4 according to this embodiment is made of an elastically deformable material, such as silicone or rubber. The anti-detachment member 4 is mounted within the mounting groove 32 and extends at least partially radially outward from the mounting groove 32 beyond the mounting groove 32. Correspondingly, an inner wall of the through hole 11 of the part 1 is provided with a stop portion 12 at the end facing away from the base 2, the stop portion 12 protruding radially inward from the inner wall of the through hole 11.

In this way, the elastically deformable anti-detachment member 4 is configured such that, on one hand, it can be allowed to pass through the stop portion 12 when the shank portion 31 of the fastening member 3 is inserted through the through hole 11 along a first direction X, so that the fastening member can be threadedly connected into the threaded hole 21 of the base 2 via the threaded section 34 of the shank portion (as shown in FIGS. 1-2), and on the other hand, when the threaded section 34 of the fastening member 3 and the base 2 transition from a connected state to a disconnected state, it prevents the fastening member 3 from detaching from the part 1 along a second direction Y opposite to the first direction X by abutting against the stop portion 12.

It can be understood that the first direction X is the mounting direction of the fastening member 3 toward the base 2, and the second direction Y is the disassembly direction of the fastening member 3 away from the base 2 and opposite to the first direction X. In this way, when the part 1 is disassembled and separated from the base 2, the fastening member 3 can be retained on the part 1 through the cooperation between the stop portion 12 and the anti-detachment member 4. When the part 1 subsequently needs to be reinstalled onto the base 2, it is only necessary to directly apply a torque to the fastening member 3 via a tightening tool, which is more convenient for maintenance, improves assembly and disassembly efficiency, and avoids any misplacement of components.

In this embodiment, the stop portion 12 is provided on the part 1, and the anti-detachment member 4 is arranged in the mounting groove 32 on the fastening member 3. Of course, it is also contemplated that in some other embodiments, the stop portion may be provided on the fastening member 3, and the mounting groove may be provided on the part 1 with the anti-detachment member 4 mounted thereon, as long as the technical purpose intended by the present disclosure can be achieved.

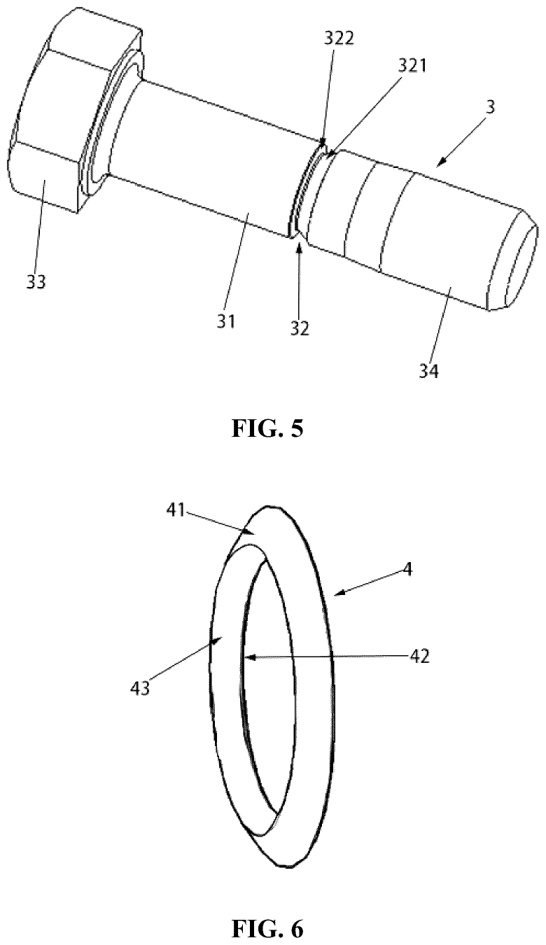

Continuing to refer to FIG. 1, FIG. 2, and FIG. 5, the mounting groove 32 is provided with a first tapered portion 321 and a second tapered portion 322, and compared to the first tapered portion 321, the second tapered portion 322 is closer to the head 33 of the fastening member 3 or, in other words, farther away from the base 2. Referring to FIG. 1 and FIG. 5 in combination, the diameter of the first tapered portion 321 gradually increases along the first direction X. The diameter of the second tapered portion 322 gradually increases along the second direction Y.

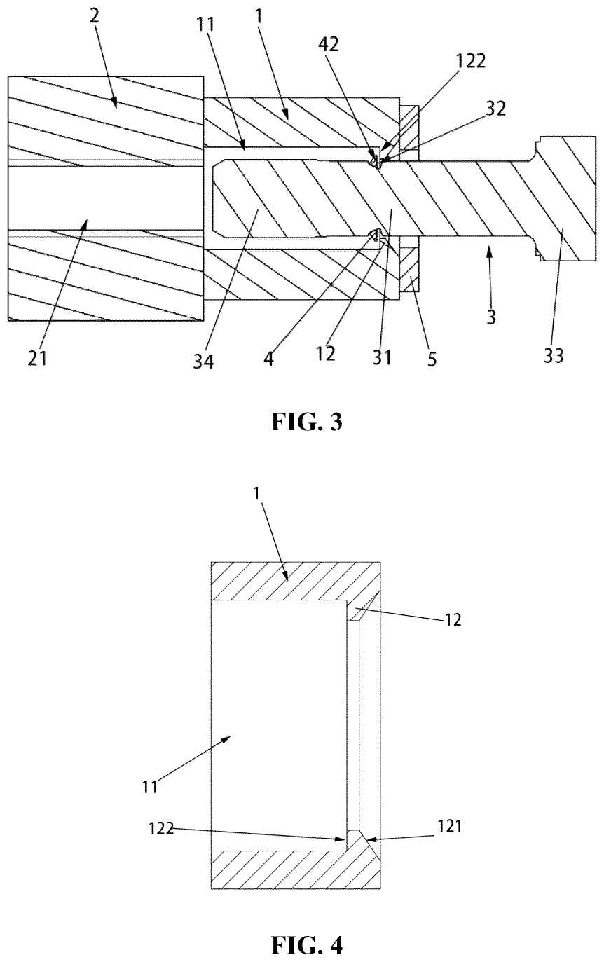

Referring to FIG. 1, FIG. 3, and FIG. 4, the stop portion 12 is in the form of an annular flange extending radially inward from the inner wall of the through hole 11 of the part, and comprises a mounting guide surface 121 and a stop surface 122. The mounting guide surface 121 is in the form of a tapered surface with a diameter gradually decreasing along the first direction X, thereby defining a mounting entry with a cross-section gradually decreasing along the first direction. The stop surface 122 extends radially inward from the inner wall of the through hole 11 and is preferably parallel to a mounting end face of the part (i.e., the end face directly or indirectly abutted by the head of the fastening member).

Referring to FIGS. 1-3 and FIG. 6, the anti-detachment member 4 is generally in a ring form and may comprise a mounting inclined surface 41, an anti-detachment surface 42, and a limiting inclined surface 43. The mounting inclined surface 41 of the anti-detachment member 4 is configured as a tapered surface, the diameter of which gradually decreases along the first direction X. Thus, in the pre-installation state where the fastening member 3 is ready to be installed to the part 1, the mounting inclined surface 41 can fit with the mounting guide surface 121, thereby utilizing the mounting guide surface 121 to provide a guide for the insertion process of the fastening member 3 into the part 1, as shown in FIG. 1.

The anti-detachment surface 42 of the anti-detachment member 4 can fit with the stop surface 122 of the stop portion 12. A portion of the anti-detachment member 4 is embedded in the mounting groove 32 of the fastening member 3, and the other portion extending beyond the mounting groove 32 can thus cooperate with the stop surface 122 of the stop portion 12 via the anti-detachment surface 42 to prevent the shank portion 31 of the fastening member 3 from slipping out of the through hole 11, as shown in FIG. 3. Additionally, since the diameter of the second tapered portion 322 of the mounting groove 32 gradually decreases along the first direction, a space is provided between the anti-detachment surface 42 of the anti-detachment member 4 in an undeformed state and the tapered surface defined by the second tapered portion 322. Thus, in the position shown in FIG. 1, when pressing the anti-detachment member 4 into the through hole 11, this space allows the anti-detachment member 4 to slide and/or rotate a certain angle within the mounting groove 32, making the anti-detachment member easier to pass through the part 1 to complete the installation of the fastening member 3, while avoiding damage to the anti-detachment member 4 due to squeezing by external forces during the pressing process.

The limiting inclined surface 43 of the anti-detachment member 4 is the surface of the anti-detachment member 4 that is in direct contact with the fastening member 3, in particular the mounting groove 32, and the limiting inclined surface is in the form of a tapered surface with a diameter gradually increasing along the first direction X, so as to match the first tapered portion 321 of the mounting groove 32. In the above embodiment, the anti-detachment member 4 is disposed on the first tapered portion 321 of the mounting groove 32 in an interference fit manner via the limiting inclined surface 43, which can prevent the anti-detachment member 4 from sliding out of the mounting groove 32 or sliding arbitrarily within the mounting groove 32.

Optionally, referring to FIGS. 1-3, the anti-detachment fastening device according to this embodiment may further comprise a washer 5 sandwiched between the head 33 of the fastening member 3 and the part 1, so that the head 33 of the fastening member 3 can indirectly abut against the part 1 via the washer 5.

In some other embodiments, when a threaded hole 21 cannot be provided in the base 2 due to the thickness of the base 2 or other conditions, the mounting hole on the base 2 can also be configured as a through hole. The corresponding anti-detachment fastening device may further comprise a nut provided at this through hole, the nut providing the internal thread required for connecting the threaded section 34 of the fastening member 3.

The present disclosure also provides a working machinery comprising a base, a part, and the aforementioned anti-detachment fastening device.

### Industrial Applicability

The anti-detachment fastening device according to the present disclosure is particularly suitable for working machinery that requires fastening a part to a base. However, it should be understood that the anti-detachment fastening device according to the present disclosure can also be used for other equipment requiring fastening two or more parts together.

Taking the embodiment shown in FIGS. 1-6 as an example, when installing/assembling the anti-detachment fastening device to the part 1 and attaching the part 1 to the base 2 via the anti-detachment fastening device, firstly, the anti-detachment member 4 is sleeved onto the mounting groove 32 of the fastening member 3 in an interference fit manner, so that the anti-detachment surface 42 of the anti-detachment member 4 faces a side where the head 33 of the fastening member 3 is located, and the limiting inclined surface 43 of the anti-detachment member 4 fits onto the first tapered portion 321 of the mounting groove 32 with a certain tension force. Then, the through hole 11 of the part 1 is aligned with the threaded hole 21 of the base 2, and the fastening member 3 with the anti-detachment member 4 is moved along the first direction X and the shank portion 31 of the fastening member 3 is inserted into the through hole 11, until the mounting inclined surface 41 of the anti-detachment member 4 abuts against the mounting guide surface 121 of the stop portion 12. Next, the shank portion 31 of the fastening member 3 is continued to be pushed further into the through hole 11. The space defined jointly by the second tapered portion 322 of the mounting groove 32 and the anti-detachment surface 42 of the anti-detachment member 4 before deformation provides an avoidance space for deformation of the anti-detachment member 4, and the outer end of the anti-detachment member 4 rotates clockwise in FIG. 1 under the action of the stop portion 12, allowing the fastening member 3 to smoothly pass through the stop portion 12 and into the through hole 11. Finally, a torque is applied to the head 33 of the fastening member 3 via a tightening tool, so that the threaded section 34 of the fastening member 3 is threadedly connected to the threaded hole 21 of the base 2.

When there is a need to detach the part 1 from the base 2, the head 33 of the fastening member 3 can be rotated reversely via a tightening tool, allowing the threaded section 34 of the fastening member 3 to disengage from the threaded hole 21 of the base 2, thereby detaching the part 1 from the base 2. At this time, on one hand, since the outer diameter of the anti-detachment surface 42 of the anti-detachment member 4 is greater than the minimum diameter of the mounting entry of the part 1, the anti-detachment surface 42 is stopped by the stop surface 122 of the stop portion 12, and on the other hand, the interaction force between the anti-detachment surface 42 and the stop surface 122 will push the anti-detachment member 4 to move along the direction where the diameter of the first tapered portion 321 of the mounting groove 32 increases, thereby ensuring that the entire anti-detachment fastening device is retained on the part 1 as a whole, thus achieving the anti-detachment design function. In this way, when the part needs to be reinstalled onto the base, it is only necessary to directly apply a torque to the fastening member, and therefore, compared to standard fasteners such as bolts and double-ended studs in the prior art, the anti-detachment fastening device according to the present disclosure is more convenient for maintenance, improves assembly and disassembly efficiency, and avoids incorrect or missed installation.

For those skilled in the art, various modifications and variations can be made to the embodiments disclosed above without departing from the scope or spirit of the present disclosure. Other embodiments of the present disclosure will be apparent to those skilled in the art from the practice of the present disclosure disclosed in this description. This description and the examples disclosed therein should be considered merely exemplary, and the true scope of the present disclosure is defined by the appended claims and their equivalents.

What is claimed is:

1. An anti-detachment fastening device, for fastening a part to a fixed base, the part being provided with a through hole, characterized in that the anti-detachment fastening device comprises:
a fastening member comprising a shank portion which is capable of being inserted into and at least partially received within the through hole, an annular mounting groove being provided on an outer circumferential surface of the shank portion; and
an elastically deformable anti-detachment member mounted within the mounting groove and extending at least partially radially outward beyond the mounting groove;
wherein a stop portion is provided inside the through hole of the part; and the anti-detachment member is configured such that, on one hand, it is allowed to pass through the stop portion when the shank portion of the fastening member is inserted into the through hole along a first direction (X), enabling the fastening member and the base to enter a connected state, and on the other hand, when the fastening member and the base transition from the connected state to a disconnected state, it prevents the fastening member from detaching from the part along a second direction (Y) opposite to the first direction by abutting against the stop portion.

2. The anti-detachment fastening device according to claim 1, characterized in that the stop portion is formed as an annular flange extending radially inward from an inner wall of the through hole of the part.

3. The anti-detachment fastening device according to claim 2, characterized in that the stop portion comprises a mounting guide surface in the form of a tapered surface, the mounting guide surface defining a mounting entry with a diameter gradually decreasing along the first direction; and the anti-detachment member has a mounting inclined surface capable of fitting with the mounting guide surface.

4. The anti-detachment fastening device according to claim 3, characterized in that the stop portion further comprises a stop surface, the anti-detachment member has an anti-detachment surface capable of fitting with the stop surface, and an outer diameter of the anti-detachment surface is greater than a minimum diameter of the mounting entry.

5. The anti-detachment fastening device according to claim 4, characterized in that the mounting groove is provided with a first tapered portion, a diameter of the first tapered portion gradually increasing along the first direction; and the anti-detachment member has a limiting inclined surface matched with the first tapered portion.

6. The anti-detachment fastening device according to claim 5, characterized in that the mounting groove is further provided with a second tapered portion located farther away from the base compared to the first tapered portion, a diameter of the second tapered portion gradually increasing along the second direction, thereby providing a space between the anti-detachment surface and a tapered surface defined by the second tapered portion when the anti-detachment member is in an undeformed state.

7. The anti-detachment fastening device according to claim 1, characterized in that the anti-detachment member is disposed within the mounting groove in an interference fit manner.

8. The anti-detachment fastening device according to claim 1, characterized in that the fastening member further comprises a head connected to the shank portion, and the anti-detachment fastening device further comprises a washer sandwiched between the head of the fastening member and the part.

9. The anti-detachment fastening device according to claim 8, characterized in that a threaded section is provided on at least part of a length of the shank portion, and the threaded section has an external thread and is intended to be threadedly connected to a threaded hole of the base.

10. A working machinery, characterized by comprising a fixed base, a part, and the anti-detachment fastening device according to claim 1 for fastening the part to the base.
